(19) United States
(12) Patent Application Publication
(10) Pub. No.: US 2026/0238720 A1
(43) Pub. Date: Aug. 13, 2026

(54) Method for managing a test of the quality of a telephone communication link

(71) Applicant: ORANGE, Issy-les-Moulineaux (FR)

(72) Inventor: Juan PASCUAL, CHATILLON (FR)

(21) Appl. No.: 19/151,796

(22) PCT Filed: Jan. 19, 2024
(86) PCT No.: PCT/EP2024/051295

§ 371 Date: Jul. 29, 2025

(30) Foreign Application Priority Data
Jan. 31, 2023 (FR) FR2300862

(51) Int. Cl. H04M 3/22; H04M 3/26

(52) U.S. Cl. CPC H04M 3/2209; H04M 3/26

(57) ABSTRACT

A method for managing a test of the quality of a telephone communication link between a terminal and a test server. The telephone communication link may be open or closed. The test is carried out when the link is open, and when carrying out the test of the quality of the link, the link is kept open regardless of whether an instruction is received to close the link by the terminal for a given duration that is at least equal to the duration required to complete the test carried out by the test server.

### CROSS-REFERENCE TO RELATED APPLICATIONS

This Application is a Section 371 National Stage Application of International Application No. PCT/EP2024/051295, filed Jan. 19, 2024, and published as WO 2024/160564 A1 on Aug. 8, 2024, not in English, which claims priority to and the benefit of French Patent Application No. FR2300862, filed Jan. 31, 2023, the contents of which are incorporated herein by reference in their entireties.

### TECHNICAL FIELD

The technical field is that of fixed telephony and in particular IP telephony, that is to say fixed telephone links made using the Internet Protocol (IP).

More precisely, the invention relates to a method for managing a test of the quality of a telephone communication link. The method according to the invention will most often be a method for managing a test of the quality of an IP telephone communication link.

Fixed telephone links are nowadays generally made using telephony platforms using the IP protocol to transmit the voice signal between telephone sets. This is then referred to as IP telephony, or also Voice over IP. The term VoIP telephony, VOIP standing for Voice over IP, is also used. Legacy fixed telephony protocols, such as PSTN (Public Switched Telephone Network) or ISDN (Integrated Services Digital Network), are being phased out.

In telephony, the name ‘terminal’ is generally given to the telephone that is at the end point of the telephone communication link and that will allow users to communicate with one another.

Telephone sets used to communicate in IP telephony are dedicated equipments called IP telephones. These IP telephones are able to establish IP communication sessions with other IP telephones by requesting IP telephony platforms. Once the session has been established between two IP telephones, a communication channel is established and voice is transmitted between the two IP telephones using the IP protocol. Sometimes, the fixed telephone does not connect directly to the IP network, but is present in a local area network and connects to a home gateway that will establish the IP telephone communication. The term ‘IP terminal’ is generally used to cover the two distinct cases of a telephone able to directly use the IP protocol and a home gateway that serves as a relay for a telephone present in its local area network. The link between the home gateway that serves as IP terminal and the fixed telephone is generally made with a DECT (Digital Enhanced Cordless Telecommunications) link.

The IP telephone communication is generally established using the Session Initiation Protocol (SIP), which is a general protocol used to establish communication sessions. Previous versions of IP telephony used the H.323 ad hoc protocol. IP telephony platforms also serve as gateways allowing IP telephones and IP terminals to access terminals belonging to other telephony networks, in particular traditional fixed telephony networks or else mobile telephony networks.

### PRIOR ART

One of the needs of telephony service operators is to be able to test the quality of telephone lines, and in particular the portion of telephone lines that is located between customers' homes and the first equipments of the telephony network. Indeed, these portions of telephone lines, which are located partially on private land, are not easily accessible to telephony service employees. Inspecting these line portions requires an appointment. A customer who observes poor quality of their telephone link will therefore contact their telephone operator, who will schedule an intervention with a technician, who will carry out the tests on the telephone link and will have to travel a priori, thereby creating a significant cost and delays before the test results are available. There is therefore a need to be able to test the quality of such a line remotely.

In the case of legacy fixed telephony networks, such as PSTN, there is a well-known technique for remotely testing telephone lines. This remote testing technique is based on the propagation properties of electrical waves in a copper medium, which is the most widely used medium in the PSTN network. By exploiting in particular the well-known echo phenomenon of electrical waves in this type of medium, it is thus possible for a telephone operator to remotely test a telephone line of the PSTN network. When a customer complains about the quality of their telephone line, a technician working for the operator will be able to perform a remote test to measure this quality and detect any problems.

For IP telephony services, such physical properties of the telephone line cannot be exploited to carry out a test remotely. However, the French patent published under number 3 063 407 on Aug. 31, 2018 and granted on Sep. 10, 2021 discloses a method for remotely testing such a communication link and an associated test server. The test server, which is present in the IP telephony network, sends a request to an IP terminal whose communication link is to be tested. After the communication has been established, the test server sends data packets to the terminal, thereby then allowing it to calculate test results and to give an indication with regard to the quality of the IP telephony communication link. The fact that the test is carried out by the server means that the IP terminal has to accept establishment of the link, which involves the test server inserting a specific parameter into the request sent by the server to the IP terminal. The test calculation may use the G.107 standard, which belongs to the ITU-T recommendations, that is to say the recommendations for the telecommunications sector of the International Telecommunication Union.

However, since such a test is triggered by a test server in the network, the method described above involves a customer having to contact the after-sales service of their telephone operator to trigger a test when they observe a malfunction on their line. Although the method introduces a possibility for remote testing, it does not allow a customer to diagnose the state of their IP telephony line without an intervention from the after-sales service of their telephone operator. Such an intervention means that there is a delay for the customer of the IP telephony service before they obtain a response with regard to the status of their line, and a significant cost for the operator of the IP telephony service in order to respond to its customers' requests. This drawback due to carrying out a test on the initiative of a server present in the network also exists in conventional telephony.

Moreover, carrying out the test in accordance with the G.107 standard means that the test server has to have a certain amount of time with the link open to the terminal in order to perform quality tests. However, a user interacting with the IP terminal could disconnect the open link with the server before the test is complete, for example by hanging up an IP telephone or a DECT telephone linked to the home gateway serving as IP terminal. This drawback due to the time taken to carry out a test also exists in conventional telephony. In this case, if the user hangs up the terminal, they may disconnect the open link with the server before the test is complete.

The invention aims to improve the situation.

### SUMMARY

According to a first functional aspect, the invention relates to a method for managing a test of the quality of a telephone communication link between a terminal and a test server, the telephone communication link being able to be opened or closed, the test being carried out by the test server when the link is open, characterized in that the opening of the telephone communication link is preceded by a request to open the link made from the terminal.

An exemplary advantage of the invention is that, since the opening of the link is preceded by a request to open the link made from the terminal, it is possible to carry out tests of the quality of the communication link on the initiative of customers of the telephony service. The test server may have a dedicated telephone number that will be called by a terminal on the initiative of a user, who will simply dial the number. This action will trigger opening of the communication link between the terminal and the test server following a request sent by the terminal. Opening the link will allow the server to start the test. The advantage of this mode is that the test is carried out on the initiative of customers, meaning that customers do not need to contact the after-sales service of the telephony service operator. The test is carried out remotely and on the initiative of customers, thereby reducing as far as possible the need to involve the after-sales service of the telephone operator.

According to one embodiment, while the test of the quality of the link is being carried out, said link is kept open, regardless of whether the terminal receives an instruction to close the link, for a given duration.

By virtue of this embodiment, the test management method ensures that the test is carried out in full by the test server. A test here is a complete interaction session between the server and the terminal that comprises multiple steps and that makes it possible to obtain an entire set of information with regard to the quality of the telephone communication link. The complete performance of such a test therefore runs over a certain duration. Completion of the test requires the server to carry out calculations for a certain amount of time. Keeping the communication link open for a given duration makes it possible to ensure that the test is indeed carried out by the test server. The given duration is at least equal to the duration needed to complete the test.

This advantage is particularly important to implement when the test is carried out on the initiative of the terminal. Indeed, the test may then be carried out by calling a dedicated number operated by the test server. It is therefore important in this case to ensure that the terminal does not hang up before the tests are completed. The invention makes it possible to ensure that, even if a user hangs up before the tests are complete, the terminal will keep the link open to ensure that the test steps are completed.

According to a first particular mode of implementation of the invention, if an instruction to close the link is received during the given duration, the execution of said instruction is postponed by another given duration.

By virtue of this mode of implementation, the instruction to close the link is postponed for a given duration but will indeed be executed later. When the closure instruction is a hanging-up operation performed by a user of the terminal, the advantage of this mode is that the test will indeed be completed, but the instruction will also indeed be performed, albeit with a delay. If the required delay is short, the user might not notice the delay in executing the closure instruction.

In another possible mode of implementation of the invention, the execution of the instruction is cancelled. This mode has the advantage of simplifying the processing of the closure instructions received by the terminal.

According to a second particular mode of implementation of the invention, which may be implemented as an alternative or in addition to the previous mode, the link is an open IP telephone communication link between the terminal and the test server, said link comprising a signaling channel allowing the test server to obtain signaling-related information, and the performance of the test of the quality of the link by the test server depends on the obtained signaling-related information.

An IP telephone communication link generally comprises two channels: a channel for exchanging signaling-related information, and therefore information relating to establishment of communication, and a multimedia data transmission channel that makes it possible in particular to exchange the voice signal between the two IP sets. It is this channel that allows users to talk to one another, their speech being transformed into IP data packets, and exchanged in both directions in the data transmission channel present in the open telephone communication link. By virtue of this mode of implementation, the test steps that are performed are divided into two categories: signaling-related tests, on the one hand, and tests relating to the transmission of data packets, on the other hand. Since the speech signal is transmitted using data packets, testing the quality of an IP telephone communication link is based mainly on tests relating to the transmission of data. However, signaling tests are also useful. One of the advantages of this mode is being able to carry out a quality test depending on the signaling information obtained. For example, the signaling information makes it possible to ascertain the IP terminal that initiated the test. The test server may then differentiate the tests depending on the terminal that initiated the opening of the link used for the test. For example, a telecommunications operator may refuse to execute tests from terminals that do not belong to its customers. Alternatively, an operator may perform more or less detailed tests depending on the subscription taken out by the customer who owns the terminal that initiated the test.

According to a third particular mode of implementation of the invention, which may be implemented as an alternative or in addition to the preceding modes, the opening of the link is preceded by a request to open the link made from the terminal.

By virtue of this mode of implementation of the invention, it is possible to carry out tests of the quality of the communication link on the initiative of customers of the telephony service. The test server may have a dedicated telephone number that will be called by a terminal on the initiative of a user, who will simply dial the number. This action will trigger opening of the communication link between the terminal and the test server following a request sent by the terminal. Opening the link will allow the server to start the test. The advantage of this mode is that the test is carried out on the initiative of customers, meaning that customers do not need to contact the after-sales service of the telephony service operator. The test is carried out remotely and on the initiative of customers, thereby reducing as far as possible the need to involve the after-sales service of the telephone operator.

This mode may be implemented when users of the terminal call a dedicated number operated by the test server; in this case, the terminal initiates the opening of the communication link, thereby triggering the execution of the test by the server.

In one variant, the telephone communication link is opened by the terminal without the involvement of a user. The terminal is programmed to open the link to the test server without human involvement. The advantage of this mode is that of being able to carry out tests on a preventative basis, and therefore to anticipate potential problems by detecting degradations of the quality of the link that would not necessarily have been detected by a user. In this variant, if the link is an IP telephone communication link, the IP terminal may be either an IP telephone or a home gateway.

According to a fourth particular mode of implementation of the invention, which may be implemented as an alternative or in addition to one of the preceding modes, the link is an IP telephone communication link and the opening of the link is preceded by an opening request made from a telephone distinct from the terminal.

By virtue of this embodiment, the invention adapts to the case, which occurs in IP telephony, where the IP terminal is a home gateway to which terminals such as DECT telephones are attached. In this case, the user of the DECT telephone, which is distinct from the IP terminal, will call a number dedicated to the test server, and therefore create a request to open the telephone communication link. This request will then be sent from the IP terminal (the home gateway) to the test IP server. The DECT telephone, which does not have an IP interface, still initiates the request to open the telephone communication link.

According to a fifth particular mode of implementation of the invention, which may be implemented in addition to either of the two preceding modes, the communication link being an open IP telephone communication link between the terminal and the test server, said link comprises a multimedia data transmission channel and the terminal sends data packets in said data transmission channel independently of instructions received via an interface of the terminal.

In the case of IP telephony, in order for a test of the quality of the IP telephone communication link to take place, it is necessary for data packets to be exchanged on the open multimedia data transmission channel. Indeed, the calculations needed to carry out the test apply to all the packets transmitted via the communication link during the duration of the test. However, if the IP terminal initiates opening of the link, including without the involvement of a user, it is necessary for the IP terminal to send data packets in the data transmission channel, even without user action on the interfaces of the terminal or, more clearly, without the user talking into the telephone. This embodiment therefore makes it possible to ensure that the test will take place in good conditions even without the involvement of a user.

According to a sixth particular mode of implementation of the invention, which may be implemented as an alternative or in addition to the preceding modes, the management method comprises the terminal receiving, during the given duration, a message from the test server and intended to be rendered by the terminal.

By virtue of this embodiment, the server sends a message, which may be for example a voice message. This message will be rendered by the terminal, for example directly on the loudspeaker of the telephone if the terminal is itself a telephone or, in the case of an IP telephony link in which the IP terminal is a home gateway, the message will be relayed by the IP terminal to a DECT telephone, which will then render the voice message on its own loudspeaker. The rendering may also take the form of rendering on a screen. The advantage of this embodiment is that of rendering a message throughout the duration of the test, and therefore of encouraging the user to remain on the line, thereby avoiding the user carrying out a hanging-up action.

According to a seventh particular mode of implementation of the invention, which may be implemented in addition to the preceding mode, the message received by the terminal comprises information relating to the test carried out by the test server.

By virtue of this embodiment, which supplements the preceding embodiment, the message received by the terminal comprises information elements concerning the results of the various steps of the test carried out by the test server. The advantage of this embodiment is that of immediately providing information to the user who called a number dedicated to the test server, and who therefore triggered the test of the quality of their communication link. In this case too, one advantage is that of limiting users' use of the after-sales service, since they have available a self-service test service that will carry out the steps of the test and provide them with the results via the message sent by the test server and rendered by the terminal.

According to a first hardware aspect, the invention relates to a management entity for managing a test of the quality of a telephone communication link between a terminal and a test server, the telephone communication link being able to be opened or closed, the test being carried out by the test server when the link is open, characterized in that the opening of the telephone communication link is preceded by a request to open the link made from the terminal.

In one embodiment, the management entity comprises a processor configured to ensure that, while the test of the quality of the link is being carried out, said link is kept open by said management entity, regardless of whether the terminal receives an instruction to close the link, for a given duration.

According to another hardware aspect, the invention relates to a terminal comprising a management entity according to one of the preceding aspects.

By virtue of this hardware aspect, it is possible to have terminals that will collaborate with a test server in order to ensure that, once a test of the quality of the telephone communication link has been started, it will not be interrupted, including in the event of actions carried out by the user of the terminal, such as a hanging-up action. The invention therefore makes it possible to have a system for testing the quality of a telephone communication link that is accessible in self-service mode for a user and that remains robust against actions carried out by the user. In general, such a terminal is a telephone. As already explained, in the case of IP telephony, such an IP terminal may be, inter alia, an IP telephone or a home gateway. It may also be a desktop or laptop computer with the ability to carry out IP telephony communications and attached to an IP telephone network.

According to another hardware aspect, the invention relates to a computer program able to be implemented by a terminal according to the preceding aspect, the program comprising code instructions that, when it is executed by a processor, carry out the management method according to the invention.

The computer programs in question may be written in any programming language. These may for example be compiled languages, or else interpreted languages, or else use a mixed mode of operation using compilation to a bytecode that will then be interpreted by a virtual machine. The programs may run on hardware architectures, or else in virtual machines, or else in similar technologies such as container systems.

According to another hardware aspect, the invention relates to a data medium on which there is recorded a computer program according to the preceding aspect.

The data media may be any entity or device capable of storing the programs. For example, the media may comprise a storage means, such as a ROM, for example a CD-ROM or a microelectronic circuit ROM, or else a magnetic recording means such as a hard disk. On the other hand, the media may be transmissible media such as an electrical or optical signal, which may be routed via an electrical or optical cable, by radio or by other means. The programs according to the invention may in particular be downloaded from the Internet. As an alternative, the information medium may be an integrated circuit into which the program is incorporated, the circuit being designed to execute or to be used in the execution of the method in question.

### BRIEF DESCRIPTION OF THE FIGURES

The invention will be better understood on reading the following description, which is given by way of example and with reference to the appended drawings, in which:

FIG. 1 shows one example of steps implemented in the context of one embodiment of the invention.

FIG. 2 shows one exemplary implementation of the invention by an IP terminal and a test server, the IP terminal being a home gateway distinct from a telephone.

FIG. 3 shows one exemplary implementation of the invention by an IP telephone and a test server.

### DETAILED DESCRIPTION

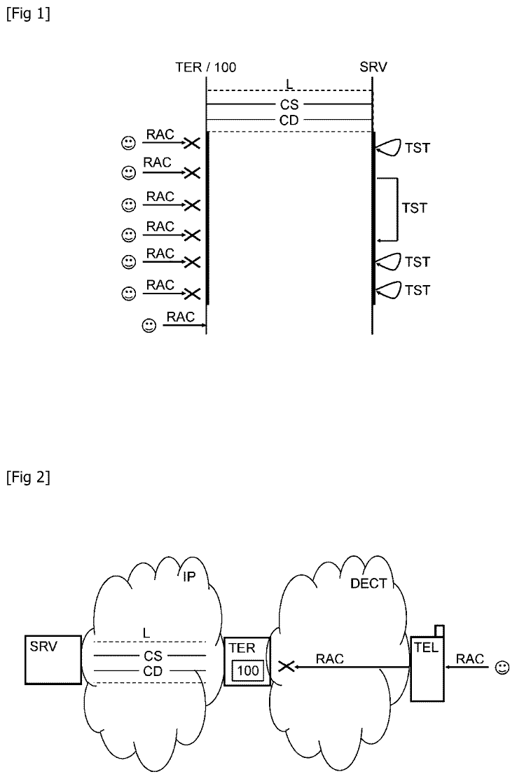

FIG. 1 shows one example of steps implemented in the context of one embodiment of the invention.

The two vertical lines represent the evolution of a terminal TER, on the one hand, and of a test server SRV, on the other hand, during the implementation of a management method according to the invention. As is conventional, the evolution of time is represented by the passage from top to bottom along the two vertical lines.

Our exemplary detailed description lies in the context of IP telephony. The test is a test of the quality of an IP telephone communication link, and the terminal TER is an IP terminal TER.

In the embodiment presented here, the IP terminal TER comprises a management entity 100 according to the invention, which implements the test management method. In other embodiments, the management entity 100 may belong to the test server SRV or else belong to service platforms, not shown in the figures, which implement the IP telephony network between the IP terminal TER and the test server SRV. However, the embodiment in which the management entity 100 is contained in the IP terminal TER is the preferred embodiment, since the management entity 100 is responsible for cancelling the effect of actions intended for the IP terminal TER, and a situation with the management entity 100 in the IP terminal TER is best suited for this.

The management entity 100 comprises a processor and possibly one or more memories (not shown in the figures) allowing it to execute programs. The presence of processors and memories in telephone terminals, or in home gateways that serve as IP terminals TER, is nowadays conventional. The processor of the management entity 100 will have to have access to the network interfaces of the IP terminal TER in order to be able to intercept the instructions to close the link L during the execution of the test. The program of the processor will also have to be able to detect that the link L must remain open. One way of proceeding may be to associate telephone numbers dedicated to the quality tests, which numbers will be stored in a memory of the management entity 100. The program implementing the method according to the invention, having access to the network interfaces of the IP terminal TER, will then detect a call to one of these numbers dedicated to the quality tests and will then start to execute the method. Another way of proceeding may be, for the test server SRV, at the start of a test of the quality of the link L, to send a specific message to the management entity 100 asking it to implement the method according to the invention and to keep the link L open for a duration at least equal to the duration needed to execute the test TST.

The IP terminal TER may take various forms.

The IP terminal TER may for example be a home gateway that provides access to the Internet in a home or small business premises. Such a home gateway will create a local area network and will have the possibility of connecting a telephone TEL to its local area network, for example using the DECT protocol. On the other hand, the home gateway will be connected to an IP telephony network as an IP terminal TER and will be able to establish IP telephone communication links for the benefit of the telephone TEL. This situation is shown in FIG. 2, which will be detailed later.

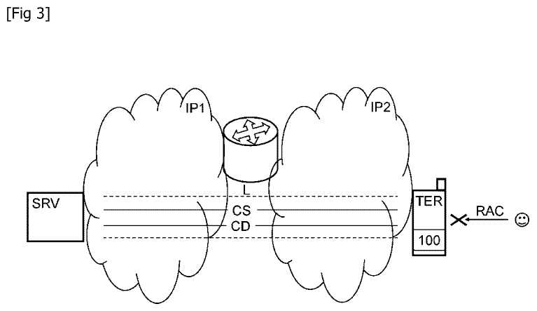

The IP terminal TER may also be a telephone capable of attaching directly to the IP telephony network. This situation is shown in FIG. 3, which will be detailed later.

The IP terminal TER may also be a desktop or laptop computer with the ability to carry out IP telephony communications and attached to an IP telephone network.

The test server SRV, for its part, generally has the hardware architecture of a conventional computer and comprises in particular a processor, a RAM (random access memory) and a read-only memory such as a Flash memory, ROM or the like, not shown in the figure, along with input/output devices such as keyboards and/or screens (not shown in the figure). The management entity may be a hardware server or else be deployed on a cloud computing architecture. The management entity has communication links (not shown in FIG. 1) that allow it to communicate with other entities in order to exchange data or instructions.

The test server SRV must be capable of being connected to IP telephone communication links in order to carry out tests of the quality of such a link. The test server SRV must therefore be connected to the IP telephony network via a communication link (not shown) and must be able to interact therewith, for example by having one or more dedicated telephone numbers on the IP telephone network and being capable of passing instructions relating to the establishment of IP telephone communication links. The test server SRV therefore has communication possibilities in line with the SIP or H.323 protocols or the like in accordance with the IP telephony protocols present in the IP telephony network for which the test server SRV will carry out tests.

The method is implemented while an IP telephone communication link L is open between the IP terminal TER and the test server SRV.

Such a link L may be opened following various events. In one simplest embodiment, a telephone number is dedicated to the test server SRV and a user of the IP terminal TER will dial this number in order to open the IP telephone communication link L. In another embodiment, the IP terminal TER will be capable of initiating the opening of the link L without the initiative of a user. In this embodiment, the IP terminal TER has programming capabilities that allow it to trigger an IP telephone call and therefore the opening of an IP telephone communication link L with the server SRV, either at scheduled times or in response to instructions not coming from a user but from other machines. The embodiment in which the IP terminal TER triggers calls to the test server SRV in scheduled fashion makes it possible to implement preventative maintenance of the quality of the IP telephone communication link L by carrying out tests at regular intervals. In another embodiment, it is the test server SRV that will trigger a call to the IP terminal TER, which will open the IP telephone communication link L.

The IP telephone communication link L comprises, in multiple embodiments, a signaling channel CS and a multimedia data transmission channel CD. The signaling channel CS is used to transfer information and instructions relating to telephone signaling, for example to the establishment of IP telephone communications, to the transfer of these communications, to the closure of the communications or to any other signaling operation. The multimedia data transmission channel CD is used, for its part, to transmit multimedia data in the form of data packets. In particular, the voice signal between the two ends of the IP telephone communication link L is transmitted in both directions in the form of data packets encoding the voice signal sent at the two ends of the link L. The protocol used to exchange such multimedia data packets is the Real-time Transport Protocol (RTP). The concepts thereof are well known to a person skilled in the art in the field of IP telephony and are not detailed any further.

Once the IP telephone communication link L has been opened between the IP terminal TER and the test server SRV, the test server will carry out a test TST of the quality of the link L. Such a test TST is a succession of steps that will make it possible to obtain an entire set of results qualifying the quality of the link L with the IP terminal TER.

It takes a significant amount of time for the test server SRV to execute the entire test TST before the results of the steps of the test TST carried out by the test server SRV are obtained. This time takes up a period represented, in FIG. 1, by a thicker line arranged on the line representing the actions carried out by the test server SRV and the IP terminal TER. Some of the steps of the test TST will be executed almost instantaneously by the test server SRV, this being represented, in FIG. 1, by looping arrows that arrive just below their starting point, representing the fact that the end of this step of the test TST takes place very shortly after the start thereof. Other steps of the test TST will, on the contrary, take a significant amount of time to execute, this being represented by arrows whose end point is significantly later than the starting point. These various steps of the test TST are labelled TST in FIG. 1 in all cases, the differentiation of the various steps of the test TST not influencing the implementation of the management method according to the invention. In all cases, it is the execution of all of the steps of the test TST by the test server SRV that takes a significant amount of time.

The steps of the test TST may be of various kinds.

The test TST may first concern IP telephone signaling. In this case, the server retrieves data transmitted via the channel CS of the IP telephone communication link L established between the IP terminal TER and the server SRV. To carry out a signaling-related test TST, the server SRV must have means for interpreting the signaling messages that will generally use the SIP protocol and possibly protocols dedicated to IP telephony, such as H.323. The test server TST will thus obtain a set of signaling-related information transmitted via the signaling channel CS.

For example, if the link L is opened on the initiative of the IP terminal TER using the SIP protocol, the test server SRV will be able to access the P-Asserted-Identity field of the SIP-Invite message. This field allows the test server SRV to obtain information concerning the IP terminal TER and in particular its telephone number and the telephony platform used by the IP terminal TER to place its call. The test server SRV may thus deduce the telephony network from which the IP terminal TER placed its call, along with the operator of the telephony service used by the IP terminal TER and possibly other commercial information.

Another example of a signaling-related test TST consists in accessing the SDP (Session Description Protocol) field present in the SIP-Invite message sent by an IP terminal TER. This field allows the test server SRV to ascertain the capabilities of the network used to establish the IP telephone communication link L between the test server SRV and the IP terminal TER. The test server TST may thus deduce the codecs (programs or hardware used to encode audio or video signals, acronym for coders-decoders) used by the IP terminal TER or imposed by the underlying network to transmit multimedia data in the channel CD of the link L.

Another example of a signaling-related test TST consists in extracting the user-agent field from the SIP messages exchanged between the IP terminal TER and the test server SRV. The test server SRV may thus deduce therefrom the model of the terminal TER located at the end of the IP telephone communication link L.

The steps of the test TST may then concern the quality of the IP telephone communication link L with regard to the transmission of multimedia data. To establish these steps of the test TST, data must be sent in the multimedia data transmission channel CD of the IP telephone communication link L. These data must in particular be sent from the IP terminal TER to the test server SRV. If the IP terminal TER initiates the opening of the link L following an action carried out by a user, that is to say when the user has used the IP terminal TER to call the dedicated number of the test server SRV, the analog audio signal recorded by the microphone of the telephone TEL or of the IP terminal TER will be encoded as data packets using a given codec, and then the packets will be sent to the test server SRV using the RTP protocol. The test server SRV will then perform a test of the quality of the link L based on the received data packets. The test server SRV must therefore have means for interpreting the data packets received in accordance with the RTP protocol.

The steps of the test TST relating to the transmission of data in the channel CD will be based on the transmission of a certain number of data packets and consist of calculations carried out on the received packets. By nature, these steps of the test TST must therefore take a certain amount of time to be carried out on a sufficient quantity of received data packets in order for the results obtained to be significant. By way of indication, the duration needed to carry out the steps of the test TST varies from a few seconds to a few tens of seconds. For this duration, the IP telephone communication link L between the IP terminal TER and the test server SRV must not be interrupted.

The steps of the test TST relating to the transmission of data will consist for example in calculating the ratio between the number of packets received by the test server SRV and the number of packets sent by the IP terminal TER. The calculation of the number of packets lost is also an interesting result of the test TST.

Another example of a test TST relating to the transmission of data in the channel CD consists in calculating jitter. Jitter is the variation in latency over time. A packet sent by the IP terminal TER will take a certain amount of time to be transmitted to the test server SRV. This transmission delay is latency. As transmission progresses, latency may decrease (packets take less time to be transmitted) or, on the contrary, increase. Jitter measures this variation in latency, and is defined for example in IETF (Internet Engineering Task Force) document RFC 3393. Multiple jitter calculation methods may be applied and give various test TST results, these methods not being detailed further.

Another example of a test TST relating to the transmission of data is to carry out the calculations defined in standard G.107, which belongs to the ITU-T recommendations, that is to say the recommendations for the telecommunications sector of the International Telecommunication Union.

In some embodiments, the performance of the test TST relating to the transmission of data by the test server SRV depends on the signaling-related information obtained during the test TST. For example, the telecommunications operator deploying the test server SRV may wish to reserve use thereof only for its customers, and will therefore use the result of a step of the test TST identifying the IP terminal TER calling the test server SRV, and will continue the test TST only if the IP terminal TER does indeed belong to the operator's customers. The steps of the test TST that are ultimately carried out may also depend on the subscription to which the IP terminal TER has subscribed and will, for example, be more detailed for a business customer than for an individual. Alternatively, the test server SRV will be able to modify the test TST that is carried out depending on the codecs used by the IP terminal TER, this being revealed by an initial signaling-related step of the test TST. Again alternatively, the steps of the test TST that is carried out will be selected depending on the model of the IP terminal TER.

In all of the embodiments of the management method according to the invention, the communication link L is kept open for the time needed to complete the test TST, regardless of whether the IP terminal TER receives an instruction RAC to close the link L. In the most common case, such an instruction RAC will be a hanging-up operation initiated by the user of the IP terminal, as shown in FIG. 1. Throughout the duration of the execution of the steps of the test TST, the management entity 100 ensures that such instructions RAC are ignored by the IP terminal TER. The IP telephone communication link L is thereby kept open, and the execution of the test TST by the test server SRV may continue. When the management entity 100 belongs to the IP terminal TER, this makes it easier to keep the link L open, even in the presence of instructions RAC received by the IP terminal TER. Indeed, the management entity 100 will be able to more easily intercept the instructions RAC received by the IP terminal TER by being included in the IP terminal TER.

In some embodiments, the duration needed for the test server SRV to complete the test TST is known in advance to the management entity 100 implementing the management method. In other embodiments, the test server SRV sends a message to the management entity 100 when all of the steps of the test TST have been carried out. The management entity 100 is thereby informed that it no longer has to implement the management method and to ensure that the link L remains open even in the presence of instructions RAC.

In some embodiments of the invention, when an instruction RAC to close the link L is received by the IP terminal TER during the given duration, the execution of said instruction RAC is postponed by another given duration. The instruction RAC will thereby ultimately indeed be executed by the IP terminal TER, but outside the period during which the IP telephone communication link L must be kept open to execute the test TST.

In other embodiments of the invention, when an instruction RAC to close the link L is received by the IP terminal TER during the given duration, the execution of said instruction RAC is cancelled. The management entity 100 ensures that the instruction RAC is not received by the IP terminal TER.

In some embodiments, the request to open the IP telephone communication link L comes from an IP interface of the IP terminal TER. For example, in one simple embodiment, a user of the IP terminal TER triggers a telephone call to a dedicated number of the test server SRV, thereby sending a request to open the communication link L between the IP terminal TER and the test server SRV. In this embodiment, the test server SRV is in self-service mode and will perform a test TST of the link L when it is called by the IP terminal TER. The management method according to the invention will then make it possible to ensure that the link L remains open and therefore that the test server SRV has the time needed to carry out the test TST even in the presence of instructions RAC to close the link L. These instructions RAC are typically hanging-up operations carried out by the user.

In other examples, the IP terminal TER sends the request to open the link L without the involvement of a user. The opening of the link L and the carrying out of the test TST are then programmed and triggered by the IP terminal TER.

In some embodiments, the request to open the link L is made from a telephone TEL distinct from the IP terminal TER. These are embodiments in which the IP terminal TER is not a telephone but, for example, a home gateway to which one or more telephones are connected within its local area network. The user will then use the telephone TEL to call the dedicated number of the test server SRV; the request to open the link L is therefore made from the telephone TEL, distinct from the IP terminal TER.

In some embodiments, the IP terminal TER sends data packets in the multimedia data transmission channel CD independently of instructions received via an interface of the IP terminal. These embodiments may be useful when the IP terminal TER initiates the opening of the link L independently of an action carried out by a user. Indeed, even in the absence of received instructions, such as sending signals from microphones, the IP terminal TER will send data packets to ensure that the test server SRV is able to carry out the test TST of the quality of the IP telephone communication link L. The management entity 100, which is responsible for carrying out the management method and therefore for intercepting the instructions RAC to close the link, will also ensure that these packets are sent during the duration needed for the test TST.

In some embodiments of the invention, the management method comprises the IP terminal TER receiving, during the given duration, a message from the test server SRV and intended to be rendered by the IP terminal TER. This message will be for example a voice message, produced by a speech synthesis component, or else a prerecorded message, which will be rendered by the loudspeaker of the IP terminal TER, when the IP terminal TER is a telephone, or sent by the IP terminal TER to a telephone TEL, which will broadcast it on its loudspeaker. The message may also comprise elements that will be able to be rendered on a screen of the IP terminal TER or of the telephone TEL.

One of the advantages of this embodiment becomes apparent when the link L has been opened at the request of a user of the IP terminal TER who has dialed the dedicated telephone number of the test server SRV. The message from the test server SRV and rendered by the IP terminal TER will make it possible to communicate information to the user relating to the progress of the steps of the test TST that are executed by the test server SRV. The message may also give instructions to the user to help carry out the test TST.

For example, the message may ask the user to press one or more keys of the IP terminal TER or of the telephone TEL. The test server SRV will thereby be capable of carrying out steps of the test TST relating to the correct functioning of Dual-Tone Multi-Frequency (DTMF) along the IP telephone communication link L.

In some embodiments, the message may ask the user to say a particular phrase. A speech recognition system present in the test server SRV will then allow it to carry out a test TST based on the quality of the received speech signal, which may be compared with the requested message.

One advantage of the test server SRV sending a message is that of encouraging the user who initiated the test TST by calling the dedicated number of the test server SRV to keep the link L open for the time needed to carry out the test TST, in other words to encourage them not to hang up RAC. All of the steps of the test TST may thereby be carried out by the test server SRV, even when this process involves testing the quality of the link L with an IP terminal TER that does not have the management entity 100. Even in the absence of a management entity 100 intercepting the instructions RAC to close the link L, this embodiment will make it possible to avoid such instructions RAC being produced. This embodiment therefore makes it possible to make available, in self-service mode, a test server SRV that will be able to be called by all types of IP terminals TER and will carry out the set of tests TST. The message sent by the test server SRV keeps the user who called the test server SRV on the line for the time needed.

In some embodiments, the message sent during the duration for which the steps of the test TST are carried out comprises information relating to the test TST carried out by the test server SRV. This information may be for example indications that the steps of the test TST have started and finished being carried out, as each of them are carried out. This information may also comprise the results of the test TST, including an overall indication regarding the quality of the IP telephone communication link L between the IP terminal TER and the test server SRV.

FIG. 2 shows the situation when the IP terminal TER is not an IP telephone. The IP terminal TER is for example a home gateway, and creates a local area network DECT to which a telephone TEL attaches. The IP telephone communication link L is then opened within an IP network between the IP terminal TER and the test server SRV. The communication link L comprises a channel CS dedicated to the transmission of signaling information and a channel CD dedicated to the transmission of multimedia data, including the voice signal between the IP terminal TER and the test server SRV. In this situation, an instruction RAC to close the link L may be received by the IP terminal TER in multiple situations, and in particular when the user of the telephone TEL performs a hanging-up action RAC on the telephone TEL. Such an action RAC is transmitted to the IP terminal TER via the DECT link. The presence of the management entity 100 implementing the management method ensures that the closure instruction RAC will not be implemented during the duration needed to carry out the test TST.

FIG. 3 shows the situation when the IP terminal TER is an IP telephone. The IP terminal TER is a telephone capable of directly implementing the necessary IP telephony protocols. The IP telephone communication link L is opened between the IP terminal TER and the test server SRV, possibly via multiple networks IP1, IP2 connected by one or more routers. The link L comprises a channel CS dedicated to the transmission of signaling information and a channel CD dedicated to the transmission of multimedia data. The management entity 100 present in the IP terminal TER makes it possible to ensure that the link L remains open even in the presence of an instruction RAC to close the link L, in this case a hanging-up instruction given by the user of the IP terminal TER.

Although the present disclosure has been described with reference to one or more examples, workers skilled in the art will recognize that changes may be made in form and detail without departing from the scope of the disclosure and/or the appended claims.

1. A method comprising:
managing a test of a quality of a telephone communication link between a terminal and a test server, the telephone communication link being able to be opened or closed, the managing comprising:
triggering the terminal to send a request to the test server to open the link; and
after triggering the terminal to send the request, managing the test with the test server when the link is open, wherein the link is opened after the request to open the link made from the terminal.

2. The method as claimed in claim 1, wherein, if an instruction to close the link is received during the given duration, execution of said instruction is postponed by another given duration.

3. The method as claimed in claim 1, wherein, the link being an open IP telephone communication link between the terminal and the test server, said link comprises a signaling channel allowing the test server to obtain signaling-related information, and performance of the test of the quality of the link by the test server depends on the obtained signaling-related information.

4. The method as claimed in claim 1, wherein the link is an IP telephone communication link and the request to open the link made from the terminal is preceded by an opening request made from a telephone distinct from the terminal.

5. The method as claimed in claim 4, wherein, the link being an open IP telephone communication link between the terminal and the test server, said link comprises a multimedia data transmission channel, and the method comprises the terminal sending data packets in the channel independently of instructions received via an interface of the terminal.

6. The method as claimed in claim 1, wherein the method comprises the terminal receiving, during the given duration, a message from the test server and intended to be rendered by the terminal.

7. The method as claimed in claim 6, wherein the message received by the terminal comprises information relating to the test carried out by the test server.

8. A management entity comprising:
at least one processor; and
at least one non-transitory computer readable medium comprising instructions stored thereon which when executed by the at least one processor configure the management entity to:
manage a test of a quality of a telephone communication link between a terminal and a test server, the telephone communication link being able to be opened or closed, the managing comprising:
triggering the terminal to send a request to the test server to open the link; and
after triggering the terminal to send the request, managing the test with the test server when the link is open, wherein the telephone communication link is opened after the request to open the link made from the terminal.

9. The management entity of claim 8, wherein the management entity is implemented in the terminal.

10. A non-transitory computer readable medium comprising a computer program stored thereon, the program comprising code instructions that, when executed by at least one processor of the management entity configure the management entity to carry out the method as claimed in claim 1.

11. (canceled)

12. The method for managing a test as claimed in claim 1, wherein, while the test of the quality of the link is being carried out, said link is kept open, regardless of whether the terminal receives an instruction to close the link, for a given duration.

13. The management entity as claimed in claim 8, wherein the instructions further configure the management entity to ensure that, while the test of the quality of the link is being carried out, said link is kept open by said management entity, regardless of whether the terminal receives an instruction to close the link, for a given duration.
